(19) United States
(12) Patent Application Publication
(10) Pub. No.: US 2008/0053594 A1
(43) Pub. Date: Mar. 6, 2008

(54) Method and Apparatus for Laminating Glass Sheets

(75) Inventor: Jari Ala-Savikota, Tampere (FI)

Correspondence Address: BUCHANAN, INGERSOLL & ROONEY PC, POST OFFICE BOX 1404, ALEXANDRIA, VA, 22313-1404, US

(73) Assignee: TAMGLASS LTD. OY, Tampere (FI)

(21) Appl. No.: 11/667,295

(22) PCT Filed: Nov. 4, 2005
(86) PCT No.: PCT/FI05/50393

§ 371 Date: Nov. 5, 2007

(30) Foreign Application Priority Data
Nov. 9, 2004 (FI) 20045427

(51) Int. Cl. B32B 37/02

(52) U.S. Cl. 156/106; 156/566

(57) ABSTRACT

A method and apparatus for laminating glass sheets in which a first glass sheet is passed onto a laminating conveyor and raised by a lift mechanism to a distance off the conveyor. The lift mechanism is held stationary and a second glass sheet is placed under the first one. A plastic film is drawn to cover the second glass sheet and the first glass sheet is lowered by the lift mechanism on top of the second glass sheet and the plastic film. This lowering process involves performing an alignment of the glass sheets by manipulating a carrier rack at a distal end of the lift mechanism's pickup arm relative to the pickup arm. Three-sheet lamination can be performed by displacing two superimposed glass sheets, with a plastic film therebetween, by the laminating conveyor from below the lift mechanism. A third glass sheet is passed onto the laminating conveyor to below the lift mechanism and raised by the lift mechanism to a distance off the conveyor. A plastic film is drawn to cover the top surface of the two superimposed glass sheets and this bundle is returned to below the third glass sheet. Finally, the third glass sheet is lowered by the lift mechanism. This arrangement is capable of providing a shorter-than-conventional laminating room, which is beneficial for the reason that the laminating room must be an air-conditioned clean space.

The invention relates to a method for laminating glass sheets, comprising passing a first glass sheet onto a laminating conveyor and raising it by means of a lift mechanism to a distance off the conveyor.

The invention relates also to an apparatus for laminating glass sheets, said apparatus comprising a body, a pickup arm, drive means for operating the pickup arm and a carrier rack with suction pads at a distal end of the pickup arm.

The prior art methods and equipment employ a lift mechanism movable along runners, which is capable of carrying an uplifted glass panel co-directionally with the laminating conveyor. This arrangement ensures a capability of laminating three or more sheets. A drawback with the arrangement is, however, that the length of a laminating room will be considerable, which in turn increases costs as the laminating room must be an air-conditioned clean space.

It is an object of the invention to provide a method and apparatus, whereby the length of a laminating room can be reduced while maintaining the capability of laminating three or more sheets.

This object is accomplished on the basis of the characterizing features set forth in the appended claims. Claim 1 discloses a method for two-sheet lamination. Claim 2 discloses a method for laminating at least three glass sheets. The independent apparatus claim 5 discloses an apparatus of the invention applicable for laminating two or more sheets. The dependent claims disclose preferred embodiments of the invention.

The invention will now be described in more detail by way of an exemplary embodiment with reference to the accompanying drawings, in which

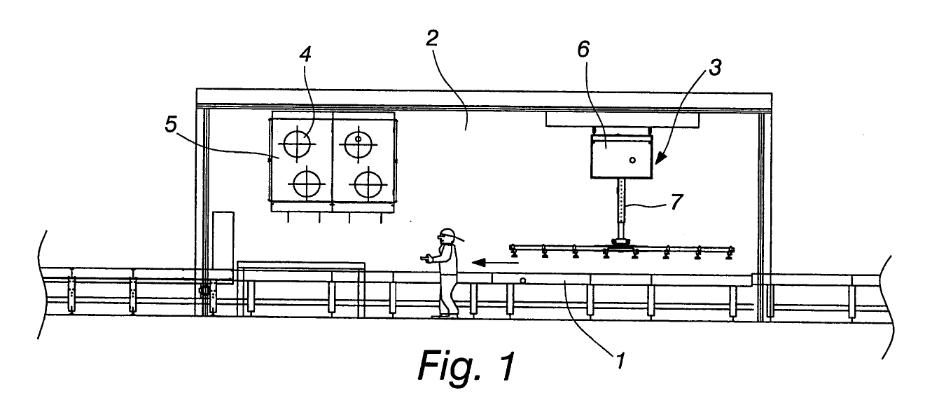

FIG. 1 shows a laminating room of the invention schematically in a side view, and

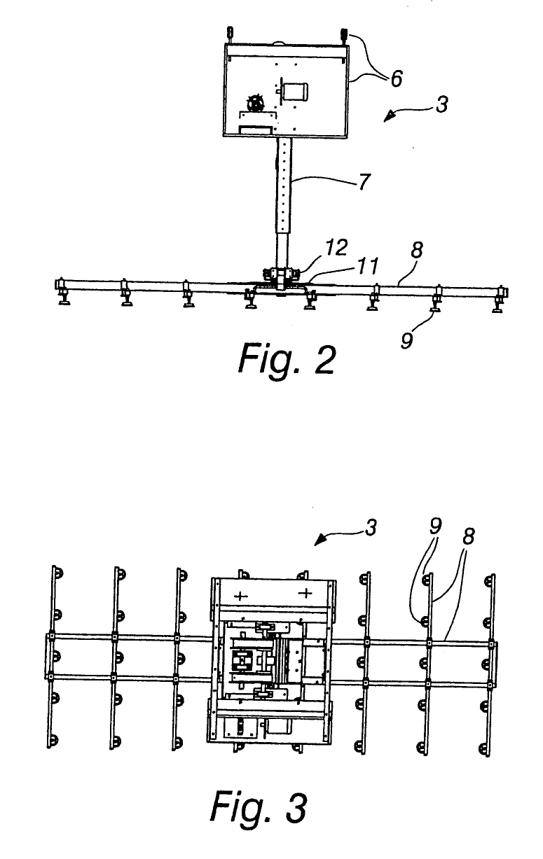

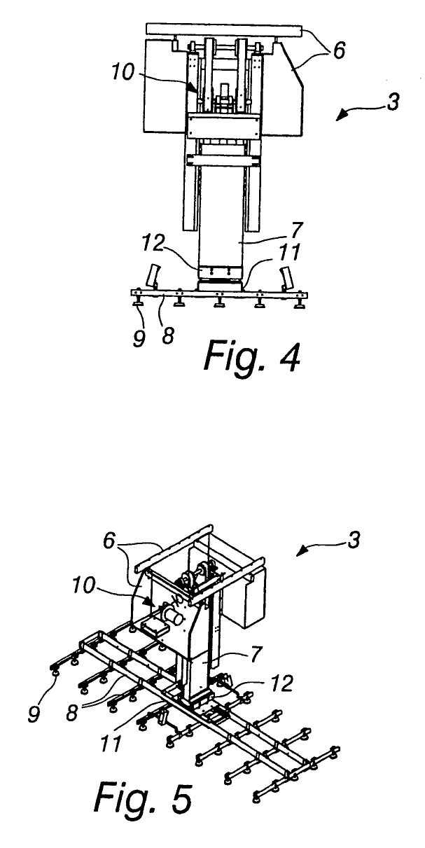

FIG. 2-5 show a lift mechanism of the invention in side, plan, end and perspective views.

In reference to FIG. 1, there is shown a laminating room, which defines a laminating space 2 and which houses a laminating conveyor 1, a lift mechanism 3, and magazines 4 for film reels 5. The magazines 5 for the film reels 4 are located, in the laminating conveyor's 1 proceeding direction, after the lift mechanism 3.

FIGS. 2-5 illustrate more specifically the lift mechanism 3 in terms of its structure. The lift mechanism 3 comprises a body 6, a pickup arm 7, drive means 10 for operating the pickup arm 7, and a carrier rack 8 with suction pads 9 at a distal end of the pickup arm 7. In the illustrated case, the pickup arm 7 is vertical and the carrier rack is mounted on its bottom end. The pickup arm 7 has a length sufficient for lifting the carrier rack 8 with its suction pads 9 to a considerable height above the laminating conveyor 1. Thus, the carrier rack 8 does not obstruct the way in the event of laminating smaller pieces of glass without using the lift mechanism 3.

What is novel about the inventive apparatus is that the lift mechanism has its body 6 fixedly attached to the ceiling of a laminating room, making it stationary in the laminating space 2. On the other hand, between the pickup arm 7 and the carrier rack 8 are provided longitudinal and lateral guides 11 and 12 for maneuvering the carrier rack 8 relative to the pickup arm 7. This mobility of the carrier rack 8 can be utilized in the alignment of glass sheets as a glass sheet held by the lift mechanism is lowered on top of a glass sheet and its plastic overlay film presently on the laminating conveyor 1.

The apparatus is operated for two-sheet lamination in the following procedure. A first glass sheet is passed onto the laminating conveyor 1 and raised by means of the lift mechanism 3 to a distance off the conveyor 1. The lift mechanism 3 remains stationary as a second glass sheet is placed under the first one. A plastic film is drawn from the magazine 5 to overlay the second glass sheet. The first glass sheet is lowered by means of the lift mechanism 3 on top of the second glass sheet and the plastic film and an alignment of the glass sheets is performed by horizontally moving the carrier rack 8 relative to the pickup arm 7 as necessary. In the event that lamination is then carried on for laminating at least three glass sheets, the two superimposed glass sheets, with a plastic film therebetween, are displaced by the laminating conveyor 1 from below the lift mechanism 3. A third glass sheet is passed onto the laminating conveyor 1 to below the lift mechanism 3 and raised by the lift mechanism 3 to a distance off the conveyor 1. A plastic film is drawn to cover the two superimposed glass sheets' top surface and said two superimposed glass sheets with the plastic film thereon are returned to below the lift mechanism 3 and the third glass sheet. The lift mechanism 3 is used for lowering the third glass sheet on top of the plastic film overlying said two glass sheets. Manipulation of the carrier rack is performed again for aligning the glass sheets. Although the glass sheets have been aligned on the conveyor prior to a passage into the laminating space, the alignment, especially with respect to the proceeding direction, is not sufficiently precise to justify omission of the carrier rack movement by its manipulation. Since the carrier rack 8 can be manipulated/moved alone relative to the rest of the lift mechanism, it is but a small mass that has to be manipulated/moved.

Possible subsequent glass panel sheets will be laminated in a similar manner, yet always incrementing said figures by one (three superimposed, a fourth glass sheet . . . etc.).

As shown in FIG. 1, the magazines 5 for the film reels 4 are located above the laminating conveyor 1 alongside the lift mechanism 3 for glass sheets (successively in conveying direction). The carrier rack 8 and the magazine 5 have a combined length in the laminating conveyor's 1 proceeding direction which is more than 50% of the length of the laminating space 2. This is not possible if the lift mechanism is displaceable on runners for placing glass sheets on top of each other. The inventive arrangement is capable of reducing the length of a laminating room by one maximum displacement distance of a glass sheet. Consequently, the carrier rack 8 may have a length which is more than ⅓ of that of the laminating space 2. The laminating space 2 has a length which is only slightly more than 2× the length of a maximum-size glass sheet, but less than 3× the length of a maximum-size glass sheet.

1. A method for laminating glass sheets, comprising passing a first glass sheet onto a laminating conveyor and raising it by means of a lift mechanism to a distance off the conveyor, holding the lift mechanism stationary and passing a second glass sheet to below the first one, wherein a plastic film is drawn to cover the second glass sheet while the second glass sheet lies under the first one, the first glass sheet is lowered by means of the lift mechanism on top of the second glass sheet and the plastic film, and an alignment of the glass sheets is performed by manipulating or moving a carrier rack at a distal end of a pickup arm of the lift mechanism relative to the pickup arm.

2. A method as set forth in claim 1 for laminating at least three glass sheets, wherein two superimposed glass sheets, having a plastic film therebetween and having been placed on top of each other by the method of claim 1, are displaced by the laminating conveyor from below the lift mechanism, a third glass sheet is passed onto the laminating conveyor to below the lift mechanism and the third glass sheet is raised by means of the lift mechanism to a distance off the laminating conveyor, a plastic film is drawn to cover the top surface of said two superimposed glass sheets and said two superimposed glass sheets are returned to below the lift mechanism and the third glass sheet, and the lift mechanism is used for lowering the third glass sheet on top of the plastic film overlaying said two glass sheets.

3. A method as set forth in claim 2, wherein possible subsequent glass panel sheets are laminated in a similar manner, yet by incrementing said figures each time by one.

4. A method as set forth in claim 2, wherein while the topmost glass sheet is being lowered by means of the lift mechanism, an alignment of the glass sheets is performed by manipulating a carrier rack at a distal end of the lift mechanism's pickup arm relative to the pickup arm.

5. An apparatus for laminating glass sheets, said apparatus comprising a laminating room, which defines a laminating space and houses a laminating conveyor, magazines for film reels, and a lift mechanism, including a body, a pickup arm, drive means for operating the pickup arm, and a carrier rack with suction pads at a distal end of the pickup arm, the lift mechanism having its body immobilized in a laminating space, wherein the lift mechanism's pickup arm and the carrier rack have guides therebetween for manipulating the carrier rack relative to the pickup arm.

6. An apparatus as set forth in claim 5, wherein the carrier rack has a length which is more than ⅓ of that of the laminating space.

7. An apparatus as set forth in claim 5, wherein the magazines for the film reels are located above the laminating conveyor alongside the lift mechanism and the carrier rack and the magazine have a combined length in the laminating conveyor's proceeding direction which is more than 50% of the length of the laminating space.

8. An apparatus as set forth in claim 5, wherein the magazines for the film reels are located, in the laminating conveyor's proceeding direction, after the lift mechanism.

9. A method as set forth in claim 3, wherein while the topmost glass sheet is being lowered by means of the lift mechanism, an alignment of the glass sheets is performed by manipulating a carrier rack at a distal end of the lift mechanism's pickup arm relative to the pickup arm.

10. An apparatus as set forth in claim 6, wherein the magazines for the film reels are located above the laminating conveyor alongside the lift mechanism and the carrier rack and the magazine have a combined length in the laminating conveyor's proceeding direction which is more than 50% of the length of the laminating space.
